(19) United States
(12) Patent Application Publication
(10) Pub. No.: US 2026/0101143 A1
(43) Pub. Date: Apr. 9, 2026

(54) MULTICHANNEL OUTDOOR AUDIO SYSTEM

(71) Applicant: Donald Burk Rowland, Pawleys Island, SC (US)

(72) Inventor: Donald Burk Rowland, Pawleys Island, SC (US)

(21) Appl. No.: 19/351,662

(22) Filed: Oct. 7, 2025

Related U.S. Application Data
(60) Provisional application No. 63/705,474, filed on Oct. 9, 2024.

(51) Int. Cl. H04R 5/02; H04S 3/00

(52) U.S. Cl. CPC H04R 5/02; H04S 3/008; H04R 2420/09; H04S 2400/01

(57) ABSTRACT

A multichannel audio system, including a wire harness having a cord protected by a jacket, the cord providing multiple audio channels; and a plurality of connector junctions that each have a fully wired connector providing access to all channels of the cord; and a plurality of high-resistance satellite speakers each having a pre-wired incomplete connector that selectably connects to the wire harness at a connector junction to access a specific channel of the multiple audio channels.

### CROSS-REFERENCE TO RELATED APPLICATIONS

This invention claims priority, under 35 U.S.C. § 120, to the U.S. Provisional Patent Application No. 63/705,474 to Rowland filed on Oct. 9, 2024, which is incorporated by reference herein in its entirety.

### BACKGROUND OF THE INVENTION

### Field of the Invention

The present invention relates to audio systems, specifically to multi-channel audio systems such as stereo outdoor audio systems.

### Description of the Related Art

In the related art, it has been known to use single channel audio systems in commercial/residential areas in order to provide a simple installation, especially for outdoor audio. This is generally done as a “constant voltage” or a high-impedance distribution audio” type system. It is possible to connect enough typical satellite speakers (8 ohm) in series/parallel combinations to achieve a reasonable impedance speaker load for the amplifier. But this type system can be difficult to install and can be unreliable, inflexible and generally requires a special amplifier. Further, failure to properly set up the system can result in damaged equipment and/or failure of the system to operate at all.

When a multichannel system is desired, the installation is even more difficult and requires more expertise to property set up, unless installing just a simple 2 speaker stereo setup. Anything more complex requires professional installation and setup.

What is needed is a multichannel audio system that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available multichannel audio systems. Accordingly, the present invention has been developed to provide a multichannel audio system.

In one nonlimiting embodiment, there is a multichannel audio system, including at least one of: a wire harness having at least one of: a cord protected by a jacket, the cord providing multiple audio channels; and/or a plurality of connector junctions that each have a fully wired connector providing access to all channels of the cord; and/or a plurality of high-resistance satellite speakers wherein it may be that one or more or each has a pre-wired incomplete connector that selectably connects to the wire harness at a connector junction to access a specific channel of the multiple audio channels.

It may be that: the plurality of high-resistance satellite speakers are each wired for either left or right audio channels, the plurality of high-resistance satellite speakers each include a voice coil that is of a resistance of greater than 10 ohms, the cord carries four audio wires, the cord carries 2 power wires, some/all of the fully wired connectors allow for selectable connection to each of the wires of the cord, the plurality of high-resistance satellite speakers each include a voice coil that is of a resistance of greater than 10 ohms and a subset of the plurality of high-resistance satellite speakers each include a voice coil that is of a resistance of greater than 20 ohms, the connector junctions and the incomplete connectors operate together as male-female connectors, and/or the plurality of high-resistance satellite speakers includes a total of eight left and right prewired speaker satellites each having an impedance of greater than 20 ohms and a subwoofer satellite speaker having an impedance greater than 12 ohms.

There may be a satellite light having a prewired incomplete connector that selectably connects to power wires of the wire harness at a connector junction. There may be a combination light and speaker satellite having a prewired incomplete connector that selectably connects to power wires of the wire harness at a connector junction and to audio wires of the wire harness.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a schematic view of a multichannel audio system, according to one embodiment of the invention;

FIG. 2 illustrates a coiled wire harness of a multichannel audio system, according to one embodiment of the invention;

FIG. 3 illustrates a wiring chart of a multichannel audio system, according to one embodiment of the invention;

FIG. 4 illustrates right and left speaker wirings of a multichannel audio system wired according to FIG. 3, according to one embodiment of the invention;

FIG. 5 illustrates a wiring chart of a multichannel audio system including power wiring, according to one embodiment of the invention;

FIG. 6 illustrates wire harness wiring of a multichannel audio system wired according to FIG. 5, according to one embodiment of the invention; and

FIG. 7 illustrates right, left, and subwoofer speaker wirings of a multichannel audio system wired according to FIG. 3, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

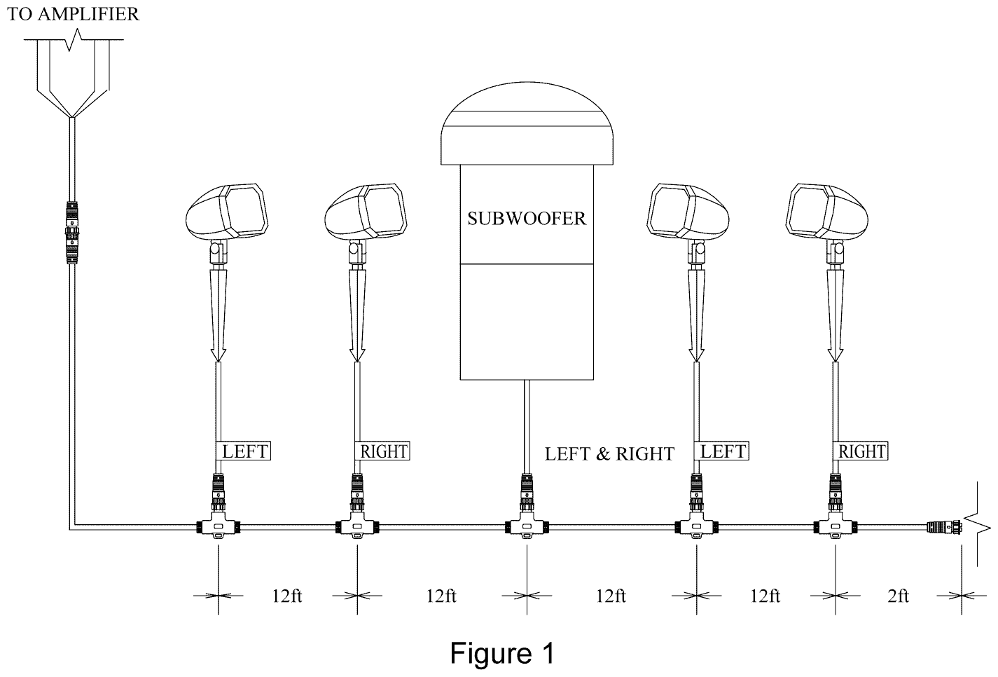

FIG. 1 is a schematic view of a multichannel audio system, according to one embodiment of the invention. There is shown a wire harness providing multiple audio channels with a plurality of connector junctions disposed spaced from each other along the cord that each have a fully wired connector providing access to all channels of the cord; and a plurality of high-resistance satellite speakers (two left speaker and two right speakers) each having a pre-wired incomplete connector that selectably connects to the wire harness at a connector junction to access a specific channel of the multiple audio channels. There is also shown a subwoofer coupled to the wire harness at a connector junction, wherein the subwoofer connector connects to both left and right audio channels.

The illustrated speakers have a high impedance compared to typical speakers which are generally 8 ohm or 4-ohm speakers. This allows for a safer and simpler wiring system and allows for speakers to be included/removed at will without risking damage to the connected amplifier. Generally, the high impedance is a result of the speaker having a high resistance voice coil, which may have a resistance greater than about 10, 12, 14, 16, 18, 20, and/or 22 ohms.

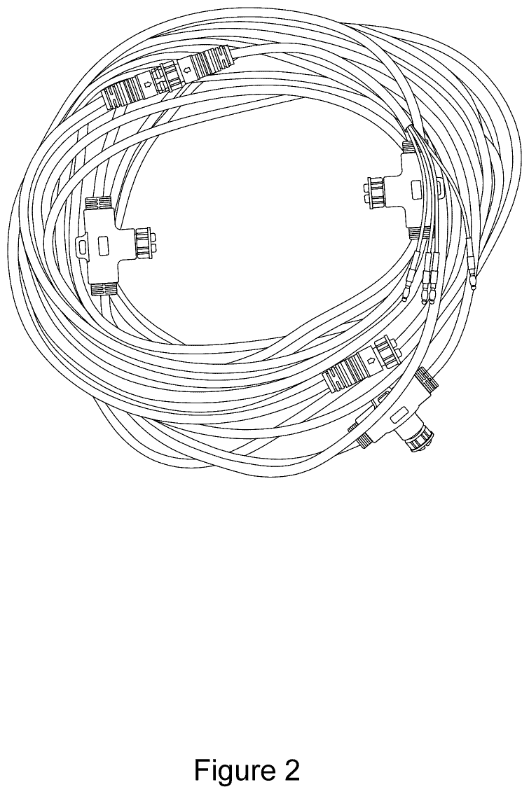

FIG. 2 illustrates a coiled wire harness of a multichannel audio system, according to one embodiment of the invention. There is shown a jacket disposed about a cord having multiple channels. The harness also includes a plurality of connector junctions spaced from each other.

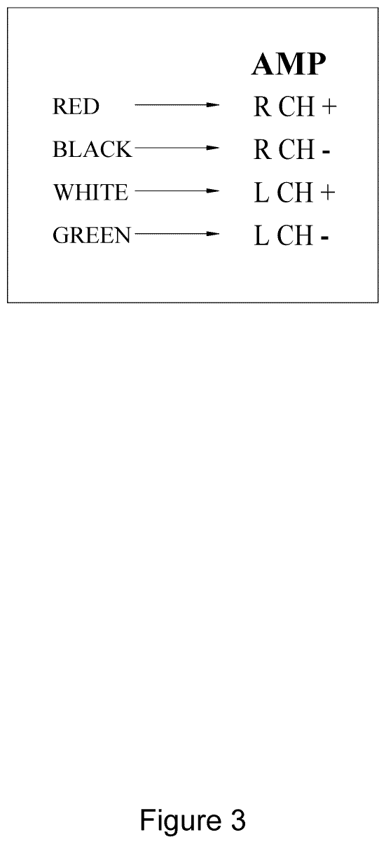

FIG. 3 illustrates a wiring chart of a multichannel audio system, according to one embodiment of the invention. In particular: the red wire of the cord is functionally coupled to the positive right channel output of the amplifier and so forth.

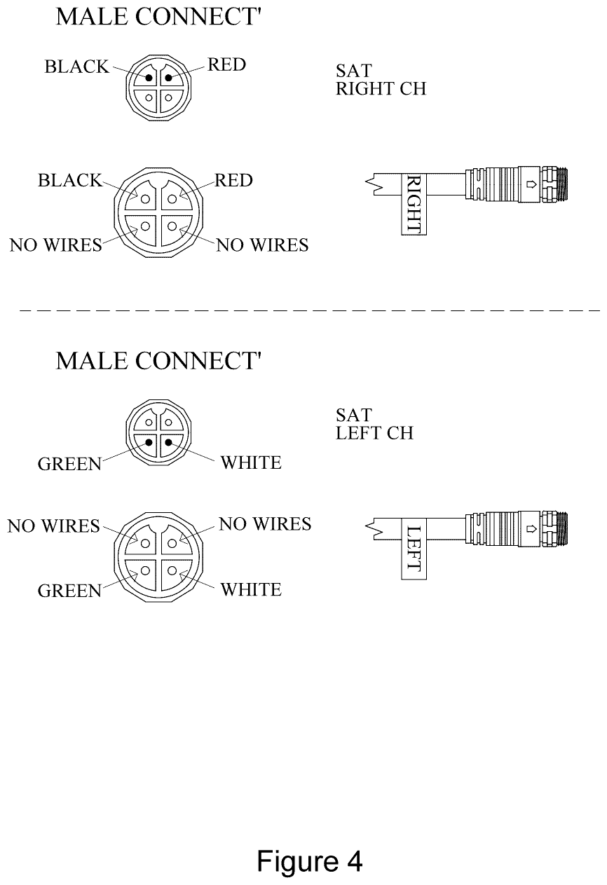

FIG. 4 illustrates right and left speaker wirings of a multichannel audio system wired according to FIG. 3, according to one embodiment of the invention. The illustrated speakers include partial connectivity via the structure of their connectors such that they only connect to the wiring of the cord that corresponds with their identification as left or right speakers. Accordingly, when plugged into the connector junctions the speakers only have access to the wired channel that corresponds with their identification even though their associated connector fully physically couples to the connector junction.

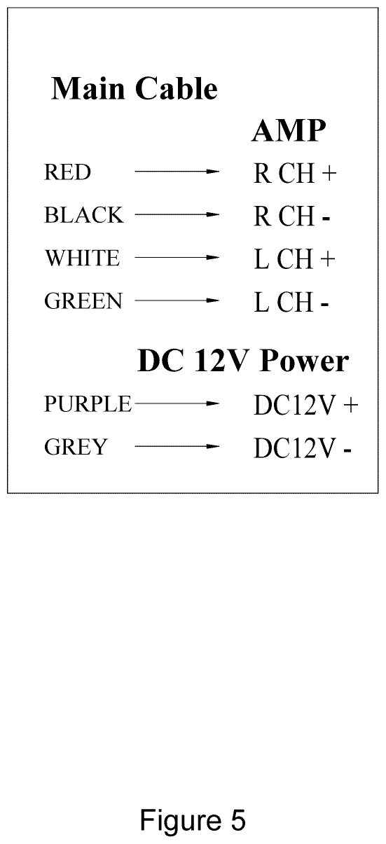

FIG. 5 illustrates a wiring chart of a multichannel audio system including power wiring, according to one embodiment of the invention. The purple and grey wires connect to the positive and negative outputs of the power supply (may be part of the amplifier) respectively.

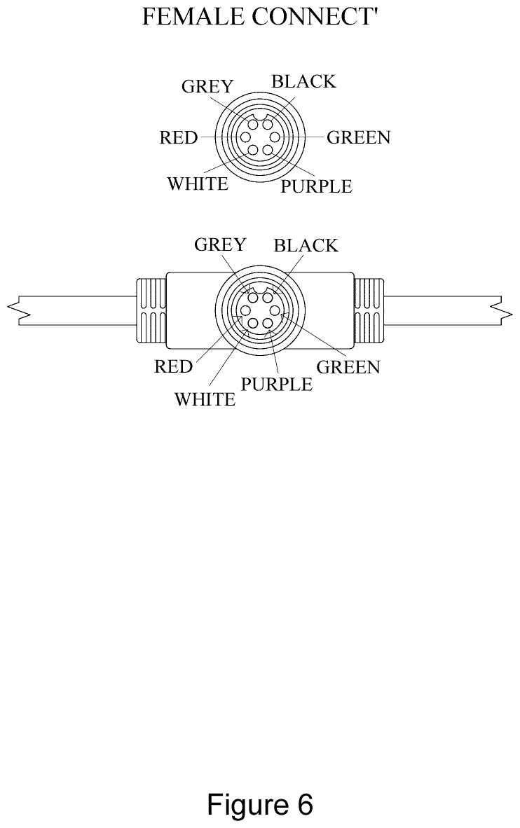

FIG. 6 illustrates wire harness wiring of a multichannel audio system wired according to FIG. 5, according to one embodiment of the invention. The illustrated connector junction provides functional access to all of the wires of the cord to any connector plugged therein.

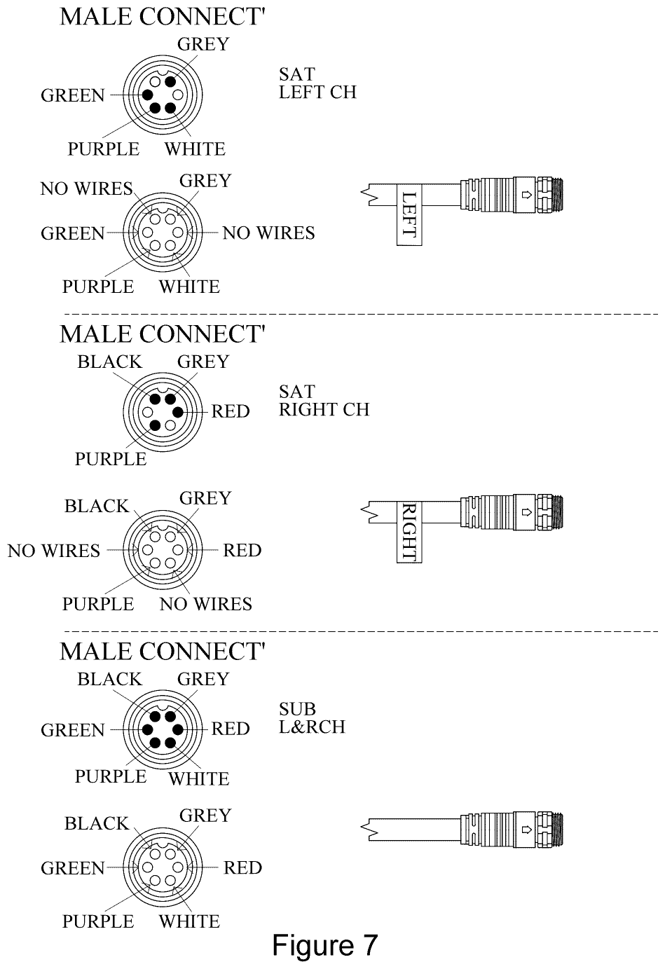

FIG. 7 illustrates right, left, and subwoofer speaker wirings of a multichannel audio system wired according to FIG. 3, according to one embodiment of the invention. The illustrated connectors provide power access from the cord to each associated satellite. The illustrated connectors for the left and right speakers include portions with no wiring so that only the channel corresponding with their identity as a left or right speaker is functionally provided to the associated speaker. The illustrated subwoofer connector and wiring provide access to both provided channels.

There may be one or more embodiments of the invention that include one or more features, functions, benefits, structures and the like as described as follows:

Voice Coils of Satellite Speakers being 25.2 ohms & DVC Subwoofer to 12.6+12.6 ohm in order to allow connection of up to 8 Sats. & 2 DVC Subwoofers to be able to safely connect to any amplifier. Allow coverage of up to 3,500 sq. ft. Components directly plug into the main cable harness without having to cut or splice any wires. Satellite Speakers include Mounting Bases to allow to be mounted several different ways without having to buy any additional brackets. A 2-Channel Stereo Soundbar that plugs directly into the main cable harness for a back-porch/gazebo TV. A 6 core cable system that not only carries the four audio wires, but also the 12V + & − wires for lighting. A Bollard LED Light with a speaker system built-in that plugs directly into the main cable harness.

In a case wherein impedance values for the satellites are as follows: 25.2 ohm on the Satellite Speakers & 12.6+12.6 ohm on the Dual Voice-Coil Subwoofer A formula to enable the connection of up to eight (8) Satellite Speakers and two (2) Dual Voice Subwoofer to be safely connected to a typical commercially available 2-Channel Stereo Receiver or Amplifier is: DC-Impedance=(Sat-Parallel Connection*Subwoofer-Parallel Connection)/(Sat-Parallel Connection+Subwoofer-Parallel Connection). In such a system, the receiver/amplifier will safely see at least 4 ohms when any combination of speakers are connected up to 8 speakers and two subwoofers. E.g. with 4 speakers and 1 subwoofer, the total impedance is 8.001, while with 8 speakers and 2 subwoofers, the total impedance is 4.0005. Speakers are prewired internally. Satellite Speakers are wired either as “Left” or “Right”. The Dual-Voice Coil Subwoofer is wired with both “Left” & “Right” and can be connected anywhere in the cable run. Noted above as “Female Socket” allows for the expansion claim. No wires to cut or splice together.

With regard to a 2-Way Stereo Soundbar: This can replace one pair of the expandable Stereo Satellite Speaker available. It may have a female in and male out connectors. The audio from the TV is broadcast to the Soundbar from the amplifier's HDMI connection. There may be a 3-Way Selector Switch on the left side . . . noted as “A” which allows play of the audio from the TV only to the Soundbar. “B” will allow the audio to play in all the other Satellite Speakers and Dual Voice-Coil Subwoofer only, and “A+B” will allow all the speakers to play the audio source selected. Note, the audio source can be of any broadcast media through the amplifier. It can be audio from the TV, streamed from a Music APP on your Smartphone, CD, etc. All sources will generally be broadcast in stereo.

With regard to the Bollard Style Stereo Satellite Speaker Light, there may be a combination of Low-Voltage LED Lighting and Stereo Speaker System that works independent of each other, or at the same time. The stereo speaker is wired internally as either “Left” or “Right”. The Low-Voltage (12V) LED Light is a standalone lighting, whereby the + Positive & − Negative wire is carried through the same Cable Connection System as the speaker wiring. Six total wires that offer a true direct connection of the light and speaker, similar to the wiring of the illustrated subwoofer.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although particular coloring schemes for wiring is illustrated, it is understood that any color scheme may be used including identification schemes not limited to and/or not including color.

Additionally, although the figures illustrate stereo systems, it is understood that the multichannel audio system described herein may include more than just two channels of audio which may be characterized in an identity scheme different from left-right.

It is also envisioned that

Finally, it is envisioned that the components of the device may be constructed of a variety of materials,

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A multichannel audio system, comprising:
a. a wire harness having:
i. a cord protected by a jacket, the cord providing multiple audio channels; and
ii. a plurality of connector junctions disposed spaced from each other along the cord that each have a fully wired connector providing access to all channels of the cord; and
b. a plurality of high-resistance satellite speakers each having a pre-wired incomplete connector that selectably connects to the wire harness at a connector junction to access a specific channel of the multiple audio channels.

2. The multichannel audio system of claim 1, wherein the plurality of high-resistance satellite speakers are each wired for either left or right audio channels.

3. The multichannel audio system of claim 1, wherein the plurality of high-resistance satellite speakers each include a voice coil that is of a resistance of greater than 10 ohms.

4. The multichannel audio system of claim 1, wherein the cord carries four audio wires.

5. The multichannel audio system of claim 4, wherein the cord also carries 2 power wires.

6. The multichannel audio system of claim 1, wherein all of the fully wired connectors allow for selectable connection to each of the wires of the cord.

7. The multichannel audio system of claim 5, further including a satellite light having a prewired incomplete connector that selectably connects to power wires of the wire harness at a connector junction.

8. The multichannel audio system of claim 1, wherein the plurality of high-resistance satellite speakers each include a voice coil that is of a resistance of greater than 10 ohms and a subset of the plurality of high-resistance satellite speakers each include a voice coil that is of a resistance of greater than 20 ohms.

9. The multichannel audio system of claim 1, wherein the connector junctions and the incomplete connectors operate together as male-female connectors.

10. The multichannel audio system of claim 5, further including a combination light and speaker satellite having a prewired incomplete connector that selectably connects to power wires of the wire harness at a connector junction and to audio wires of the wire harness.

11. The multichannel audio system of claim 1, wherein the plurality of high-resistance satellite speakers includes a total of eight left and right prewired speaker satellites each having an impedance of greater than 20 ohms and a subwoofer satellite speaker having an impedance greater than 12 ohms.
